(19) United States
(12) Patent Application Publication
(10) Pub. No.: US 2026/0346546 A1
(43) Pub. Date: Nov. 5, 2026

(54) MENISCUS-ENABLED PROJECTION STEREOLITHOGRAPHY

(71) Applicants: Pranav Soman, Chittenango, NY (US); Puskal Kunwar, Syracuse, NY (US)

(72) Inventors: Pranav Soman, Chittenango, NY (US); Puskal Kunwar, Syracuse, NY (US)

(73) Assignee: Syracuse University, Syracuse, NY (US)

(21) Appl. No.: 19/485,901

(22) PCT Filed: May 20, 2024
(86) PCT No.: PCT/US2024/030214

§ 371 Date: Nov. 19, 2025

Related U.S. Application Data
(60) Provisional application No. 63/467,668, filed on May 19, 2023.

(51) Int. Cl. B29C 64/321; B29C 64/129; B29C 64/232; B33Y 10/00; B33Y 30/00; B33Y 40/00

(52) U.S. Cl. CPC B29C 64/321; B29C 64/129; B29C 64/232; B33Y 10/00; B33Y 30/00; B33Y 40/00

(57) ABSTRACT

A multi-material printing platform using meniscus enabled projection stereolithography (MAPS) that is a vat-free method that relies on the generation and continuous maintenance of a liquid meniscus between a photopolymer resin, bottom PDMS substrate, and the Z-stage to print lateral, vertical, discrete, or gradient multi-material 3D structures with little-to-no cross-contamination or waste. MAPS is compatible with a wide range of photopolymers and can print complex multi-material 3D structures without the need for specialized hardware or software or complex washing protocols. MAPS has the ability to print structures with microscale variations in mechanical stiffness, opacity, surface energy, cell densities, and magnetic properties provides a generic method to make advanced materials for a broad range of applications.

This invention was made with government support under Grant Nos. R21AR076645-01 and R21GM141573 awarded by the National Institutes of Health (NIH). The government has certain rights in the invention.

### BACKGROUND OF THE INVENTION

### 1. Field of the Invention

The present disclosure relates to additive manufacturing processes and, more specifically to an approach for performing projection stereolithography that avoids the need for a vat by forming a resin meniscus formed between the crosslinked structure and the substrate.

### 2. Description of the Related Art

Current additive manufacturing methods are unable to match nature's marvelous ability to arrange multiple materials in 3D configurations across scales to realize multifunctional structures. Extrusion or jetting methods with the use of multiple printing nozzles have been used to print multi-material structures, however, the print resolution, surface finish, shape fidelity, and speed are typically lower than vat photo-polymerization methods such as Projection stereolithography (PSLA) or digital light processing (DLP). A typical setup for PSLA consists of spatially modulated light patterns projected through a transparent bottom window to polymerize photosensitive liquid resin in a vat. The ever-growing library of resin formulations has already allowed PSLA to fabricate functional structures for applications in tissue engineering, soft robotics, photonics, and other fields. Despite this progress, multi-material printing with PSLA or similar methods remains challenging due to limits of hardware modifications, complex control systems, resin properties, and associated constraints on design complexities.

Advances such Continuous liquid interface production (CLIP), high-area rapid printing (HARP), and Computed axial lithography (CAL), have improved printing speed, however their ability to print multiple materials remain limited. Current multi-material PSLA methods continue to rely on proprietary hardware modifications such as the use of multiple vats, carousel style rotators, linear movement of print stages, wiping mechanisms, and pressurized fluid flow to facilitate resin exchanges. Instead of relying on passive refilling of resins, active methods such as lateral (XY) stage motions in mask video projection based stereolithography (MVP-SL) or active perfusion of resin using viaducts embedded within the print geometry (Injection CLIP or iCLIP), have been developed to accelerate refilling of resins. However, the adhesion of unpolymerized monomers or residues during washing, drying, or light irradiation steps often results in cross-contamination. With methods such as CAL, that rely on projection of light patterns onto a rotating resin vat, is possible only when the second material is printed around pre-existing prints. Other strategies of greyscale light exposure or orthogonal dual-wavelength printing require customized resin photochemistry. Additionally, resin properties continue to play a dominant role in determining the printing capabilities of current methods. For instance, resins that are miscible with the lubricating liquid, necessary for rapid printing, cannot be used with HARP. DLP-based CM method is limited to materials that could withstand the centrifugal washing steps while CAL is limited to resins that exhibit high viscosity, high reactivity, and low scattering properties.

Vat-free methods, that involve puddles of resins or smaller droplets with lateral or vertical stage movements, have also been used, although challenges related to separation forces between glass and polymerized parts, air-cleaning of high viscosity resins, and flow of large puddles remain. In summary, despite recent advances, multi-material methods require substantial hardware and software modifications, and key challenges related to resin refilling, contaminations during resin exchanges, and low recyclability due to unpredictable amounts of photoreactive components have not been addressed. Printing structures with custom gradient properties using the current method faces limitations, particularly in achieving consistent and accurate gradient transitions across the printed object. While the VAT-based method has been employed for printing gradient structures, it suffers from poor control over the resin's composition during the printing process, primarily due to issues like residue buildup and cross-contamination due to use of VAT. These factors hinder the ability to precisely manipulate the resin's properties required for successful gradient printing, emphasizing the need for improved techniques to overcome these challenges. Accordingly, there is a need in the art for a projection stereolithography approach that can avoid the need for a vat that is capable of printing 3D structures with custom variations in lateral, vertical, discrete, or gradient properties with little-to-no cross-contamination, waste or complex hardware or operating protocols.

### BRIEF SUMMARY OF THE INVENTION

The present invention is a projection stereolithography platform that employs a meniscus to provide a vat-free method capable of printing 3D structures with custom variations in lateral, vertical, discrete, or gradient properties with little-to-no cross-contamination or waste and without requiring complex hardware or operating protocols. The present invention can be used to print 3D structures with custom variations in stiffness, opacity, surface energy, cell density, and magnetic properties. In an embodiment of the present invention, the approach comprises a method of performing projection stereolithography by providing a Z-stage capable of movement along a first axis, providing a transparent substrate below and spaced apart from the Z-stage, pumping an amount of resin from a source of resin onto the substate, providing a source of illumination below the substate and directed upwardly to selectively cause polymerization of the amount of resin on the substrate with the source of illumination, and moving the Z-stage upwardly while continuously pumping an additional amount of resin onto the substate at a rate sufficient to form a meniscus between the substrate and the selectively polymerized resin.

In a first aspect, the invention includes system for performing projection stereolithography having a z-stage capable of movement along a vertical axis, a transparent substrate positioned below and spaced apart from the Z-stage, a first continuous flow pump positioned to deliver an amount of resin onto the transparent substrate, and a source of illumination positioned below the transparent substrate and oriented to direct illumination through the transparent substrate. The z-stage is capable of movement along the vertical axis during operation of the first continuous flow pump at a rate to form a meniscus in the amount of resin between the transparent substrate and the z-stage and to maintain the meniscus when the source of illumination is operated to cure of a portion of the amount of resin. The system may include a micromirror device positioned between the source of illumination and the transparent substrate. The z-stage may be configured to move upwardly by 200 μm to form the meniscus and then downwardly by 150 μm when the source of illumination is operated to cure a 50 μm layer of the resin. The transparent substrate may be formed from polydimethylsiloxane. The transparent substrate may be etched to define a flow path for the amount of resin. The system may further comprise at least a second continuous flow pump positioned to deliver a second amount of resin onto the transparent substrate. The first amount of resin and the second amount of resin are different. The first continuous flow pump and the second continuous flow pump may be connected to a microfluidic mixer that provides a combination of the first amount of resin and the second amount of resin to the transparent substrate. The first amount of resin and the second amount of resin have different colors.

In another aspect, the invention may be a method of performing projection stereolithography. The steps may include providing a Z-stage capable of movement along a first axis, positioning a transparent substrate below and spaced apart from the Z-stage, positioning a continuous flow pump to pump a first amount of resin onto the transparent substrate, providing a source of illumination below the transparent substrate that is oriented to selectively cure a portion of the amount of resin, pumping the amount of resin onto the transparent substrate to form a meniscus between the z-stage and the transparent substrate, moving the Z-stage upwardly while continuing to pump the first amount of resin onto the substrate to maintain the meniscus; and selectively polymerizing a region of the first amount of resin on the substrate with the source of illumination. The method may include the step of selectively polymerizing a region of the amount of resin on the substrate with the source of illumination includes using a micromirror device positioned between the source of illumination and the transparent substrate. The z-stage may be moved upwardly by 200 μm when the continuous flow pump is pumping resin and then downwardly by 150 μm prior to the step of selectively polymerizing the region of the amount of resin so that a 50 μm layer of the resin is cured. The step of using at least a second continuous flow pump to deliver a second amount of resin onto the transparent substrate. The first amount of resin is different than the second amount of resin. The first continuous flow pump and second continuous flow pump are coupled to a microfluidic mixer that provides a mixture of the first amount of resin and the second amount of resin to the transparent substrate. The first amount of resin and the second amount of resin have different colors. The method may include the step of moving the z-stage upwardly after the step of selectively polymerizing the region of the amount of resin to raise the region of resin that has been polymerized and form a second region of the amount of resin on the transparent substrate under the region of resin that has been polymerized. The method may further include the step of selectively polymerizing the second region of the amount of resin.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is: (A) Illustration of vat-based PSLA consisting of spatially modulated light patterns projected through a transparent bottom window to polymerize photosensitive liquid resin in a vat in discrete layers or in a continuous fashion to print the final 3D structure. Schematic setup illustrating the MAPS printing of 3D structure by a continuous flow of photopolymer solution using a syringe pump. The diagram shows the positive and negative forces involved in pulling the material into the fabrication area. (B) (i-iv) Process flow diagram of steps involved in MAPS. The up-down step elevation of the z-stage draws the liquid into the fabrication area, while the projection of the 405 nm spatially patterned light crosslinks the prepolymer solution. (C,D) Photographs and plots showing the lateral and axial resolutions of the printed structure using PEGDA 400 MW (E,F) Lattice cube and the Statue of Liberty in PEGDA 400 MW are fabricated using MAPS.

FIG. 2 (A) is a schematic of a custom-built MAPS printing setup consists of a 405 nm laser system, 4f lens-telescope system, rotating diffuser for converting the Gaussian intensity distribution of light to hat-shaped intensity, DMD, projection optics, polymer holder with PDMS as bottom window, stage (advancing part) mounted on programmed PI z-stage. Inset shows the zoomed image of MAPS printing depicting the meniscus governed by two contact angles (θ1 and θ2). Contact angle 1 (θ1)-contact angle formed by resin on PDMS. Contact angle2 (θ2)-contact angle formed by resin on the crosslinked structure. (B) is schematic setup illustrating the MAPS 3D printing by a continuous flow of resin solution using syringe pumps and an inline micromixer. (i) ormation of the three-phase contact line and resin shape dictated by γ^{R}-resin surface tension, γ^{P}-PDMS surface tension, γ^{PR}-resin-PDMS boundary tension, and contact angles θ1 and θ2. (ii) Illustration of contact angle θ2 once the structure starts to print. (iii) Shape of the meniscus that acts as a reservoir for MAPS printing.

FIG. 3 is a series of image of MAPS printed 3D structures using different commercially available resins (A) B9Creations Black resin (B) Liqcreate Flexible-X (C) PhotoCentric 3D grey (D) Liqcreate Composite-X (E) Siraya Tech Blu (F) Siraya Tech Sculpt (G) eSUN eResin-Elastic (Scale bars-5 mm).

FIG. 4 is: (A) Schematic diagram of (i) flow of photopolymer to the fabrication area with low wettability (ii) breakage of flow during the printing process (iii) continuous flow of photopolymer to the fabrication area with high wettability. (B) Inducing hydrophilicity in PDMS slab by treating it with oxygen plasma. (i-iv) Patterning wettability on PDMS surface using mask and oxygen plasma etching. (v) Demonstrating patterned wettability by containing water within the etched pattern on PDMS (Scale bar-5 mm). (C) (i) System setup of the computational fluid model of droplet-based printing, with simulation results of different wetting contact angles of the substrate ranging from (ii) θ1=20°, (iii) θ1=45°, (iv) θ1=90° and (v) θ1=110°. Results show that the variation of substrate wettability changes the liquid adhesion on the substrate. (D) Different configurations of sample holders used in this study. (i) Side tube configuration. (ii) Top tube configuration. (iii) Side channel configuration with the slanting angle design.

FIG. 5 is a series of images of contact angle measured for different photopolymers on native PDMS and oxygen plasma-treated PDMS.

FIG. 6 is a schematic of Multimaterial printing on the MAPS platform. (A) The schematic depicts multimaterial printing using two flow pumps. (B) Multimaterial printing without cleaning steps: (i) Statue of Liberty (scale bar-5 mm) and (ii) knotted vessel printed using PEGDA 250 and Photocentric grey resin (scale bar-5 mm). (C) Multi-material printing demonstrated with cleaning steps: (i) Statue of Liberty printed using PEGDA 250 MW and Black resin (scale bar-5 mm). (ii) Arrays of 3D pillars with checkerboard roofs (scale bar-5 mm). (iii-iv) Showcased is multi-material printing of hard material (90% PEGDA 700) and soft material structure (10% PEGDA 6k), where the structure was immersed in water to highlight the morphology of the soft structure (Scale bar—2 mm). (iii-iv) Shown is multi-material printing of biologically inert (10% PEGDA 6k) and biologically active material (10% GelMA) (Scale bar—2 mm), where (inset) cells exhibited greater attachment and proliferation on the biologically active material (Scale bar-1 mm). (D) (i,ii) Contact angle formed by water drop is compared for slabs printed with PEGDA 6k, and PEGDA 250. (iii) Schematic of alternating layers of hydrophobic (PEGDA 250) and hydrophilic (PEGDA 6k) material. (iv) Contact angle measurements of a water drop on a printed slab made of alternating layers of hydrophobic and hydrophilic material (Scale bars-1 mm). (E) (i) CAD design and (ii) 3D printed three-channel cell culture microfluidic device printed using PEGDA 6k (base below central channel) and PEGDA 250 (rest of the chip). Inset shows the zoom images of triangular pillars to contain the dye within the central channel. (iii) Food-colored dye water flows outside of the central channel when the cell culture chip is printed using single material (PEGDA 250) (Scale bar-3 mm).

FIG. 7 is a series of images of contact angle (θ1) measured for photo-centric grey photopolymer on native PDMS and oxygen plasma-treated PDMS. The contact angle (θ2) for this polymer was also measured on the photo crosslinked slab of the polymer. Further, the contact angle (θ2) was also measured for PEGDA photopolymers, which showed complete wetting of a crosslinked slab (not shown in the figure).

FIG. 8 is (A) Schematic MAPS setup for gradient printing. (B) (i-ii) Design of the microfluidic mixer is shown, including the overall structure and mixing architecture of the mixer. (iii) Computer-generated masks and as-printed microfluidic mixers are also presented. (iv) The mixer is printed using MAPS technology using PEGDA 250 hydrogel (Scale bar—2 mm)

FIG. 9 is a series of images of the performance of the microfluidic mixer is evaluated by mixing two colors PEGDA 6k at different time points, which are depicted in three images: (i) t=0.5 min, (ii) t=9 min, and (iii) t=18 min (Scale bar—2 mm) and (iv) a plot that illustrates the flow rate of milky white PEGDA 6k and green PEGDA 6k and the efficiency of mixing, which is estimated in terms of the color intensity of green dye at the outlet channel

FIG. 10 is a series of images showcases various gradient printing examples. (A) (i) displays the CAD design of the twisted tower (ii) exhibits the two-color gradient printing of the twisted tower using green and yellow color PEGDA 700 hydrogels (scale bar-2 mm). (iii) shows the RGB intensity plot along the black line. (B) (i) exhibits the twisted tower with a material gradient of PEGDA 700 and PEGDA 6k (Scale bar 2 mm). (ii) shows the twisted tower with a material gradient of PEGDA 700 and PEGDA 6k by reversing the flow rate (Scale bar—2 mm). (iii) displays the flow rates for PEGDA 6k and PEGDA 700 and exposure time. (iv) shows the compression test performed to evaluate the properties of the as-printed gradient twisted tower structure at different sections marked by a black rectangle. (C) (i, ii) displays the front and back views of the gradient liberty tower structure printed using PEGDA 250 and photo-centric grey (scale bar-5 mm). (iii) displays the flow rates for PEGDA 250 and photocentric grey resin and exposure time. (D) shows the multimaterial gradient knotted vase printing using two inlets and a multimaterial gradient structure printed exponentially varying the pump rate (Scale bar-10 mm).

FIG. 11 is (A) Cylindrical structure printed using a resin with Carbon black NPs additive (Scale bar—2 mm). (ii) Compressive stress-strain plot of the cylinder section marked by yellow rectangles. (iii) Bar-plot showing the maximum stress required to break the respective sections. 6k (B) B (i-iii) Magnetic response shown by structures containing homogeneous magnetic NPs, gradient distributed NPs, and no NPs (Scale bar—2 mm). (iv) All of these structures showed a distinct response to the magnetic field (C) (i) schematic representation of the bio construct printed using MAPS, featuring a gradient property. (ii) The DAPI-stained construct was sliced, and a section was viewed under a fluorescence microscope. (iii) F-actin staining of the sliced construct (iv) Demonstration of the gradient distribution of bone mineral in the sliced construct cultured for 3 weeks (Scale bar 500 pm)

FIG. 12 is a confocal image of the (A) uniform spatial distribution of cells and (B) gradient distribution of cells in a 3D printed construct with a viability of 93%. Units are in μm.

FIG. 13(A) is the utilization of multiple inlet ports for the 2.5× scaled reproduction of the Liberty Statue. (B) A comparison is made between the structure printed with Scaled-MAPS and the statue printed with MAPS. (Scale bar: 1 cm)

FIG. 14 is a CAD design of (A) single-channel and (B) four-channel sample holder. (C) Detailed dimensional and design of four-channel sample holder.

### DETAILED DESCRIPTION

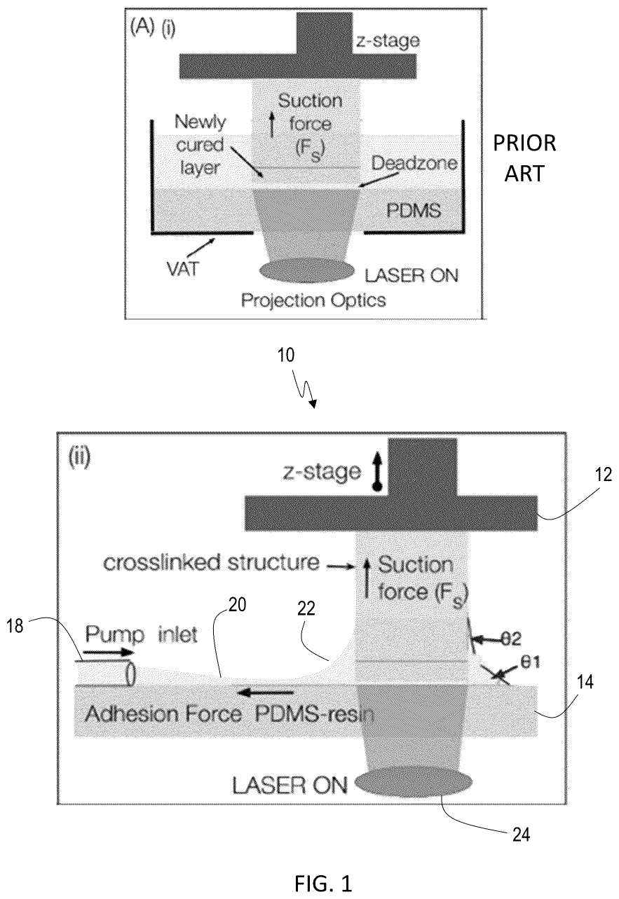

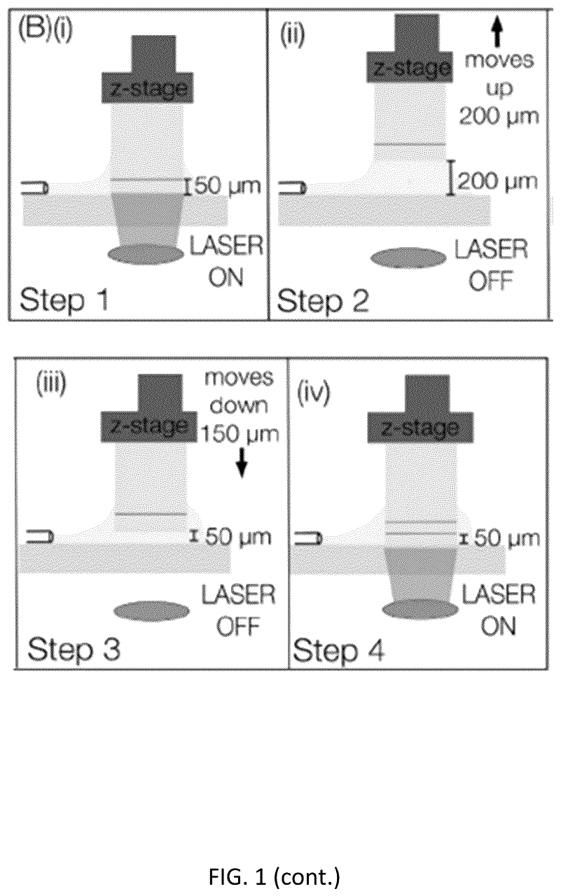

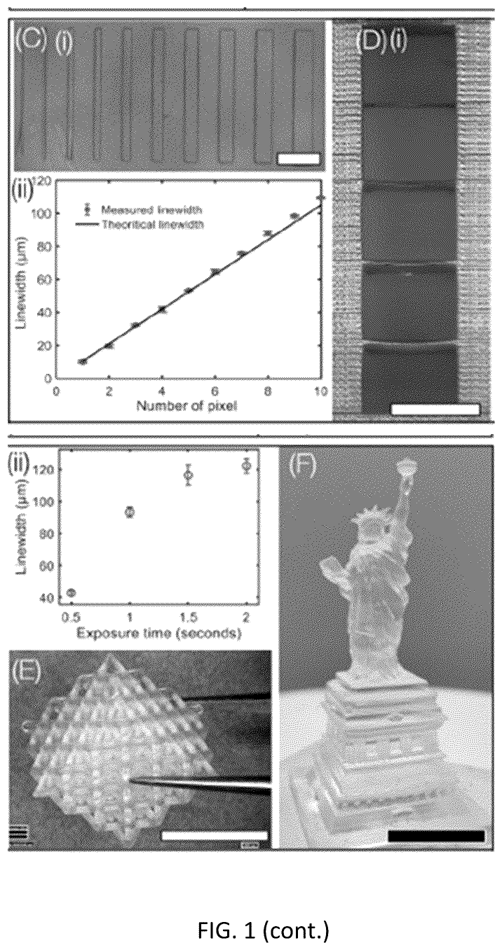

Referring to the figures, wherein like numerals refer to like parts throughout, there is seen in FIG. 1 a schematic of a meniscus enabled projection stereolithography (MAPS) system 10 according to the present invention. System 10 includes a z-stage 12, a transparent substrate 14 positioned below z-stage 12, and a continuous flow pump 18 positioned to direct an amount of a resin 20 onto transparent substrate 14. Pump 18 and z-stage 12 are operated in tandem to form a meniscus 22 of resin 20 between z-stage 12 and transparent substrate 14 that is maintained during polymerization by an illumination source 24 positioned below transparent substrate 14.

As compared to current vat-based methods, MAPS relies on the generation and continuous maintenance of a resin meniscus between crosslinked layers and the bottom PDMS window. The formation of a meniscus occurs when resin, a PDMS layer, and air come into contact, creating a three-phase contact line. This process is controlled by the balance of tangential forces resulting from interfacial and surface tensions. These combined forces result in the formation of a resin dome, with a contact angle denoted as θ1, between the resin and the PDMS window. As the print starts and progresses, another contact angle (θ2) is also formed between resin and crosslinked structures. This leads to the formation of a resin meniscus, which serves as a reservoir for the MAPS printing process.

Resin is continuously drawn from the meniscus into the fabrication area, while the fluidic pump replenishes the amount of material used during printing, ensuring the meniscus remains intact throughout the entire process, as seen in FIG. 1A. The prepolymer solution is drawn into the fabrication window through the suction force (Fs). The majority of Fs is utilized to pull the resin against the PDMS interface, while a fraction of force is also applied against the adhesion of the interface between the prepolymer solution and the crosslinked structure. Through this process, the photopolymer is effectively transferred from the meniscus to the fabrication area. The flow rate of the pump and the suction force (Fs) work in tandem to transport the resin from pump inlet to the meniscus.

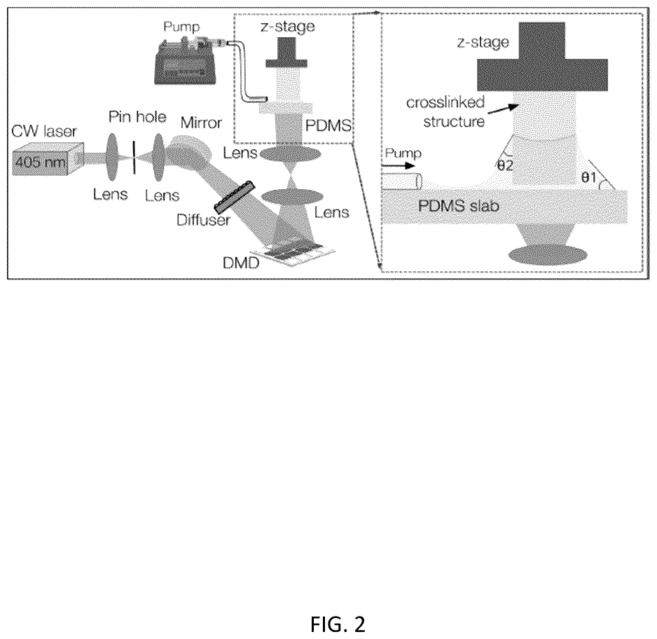

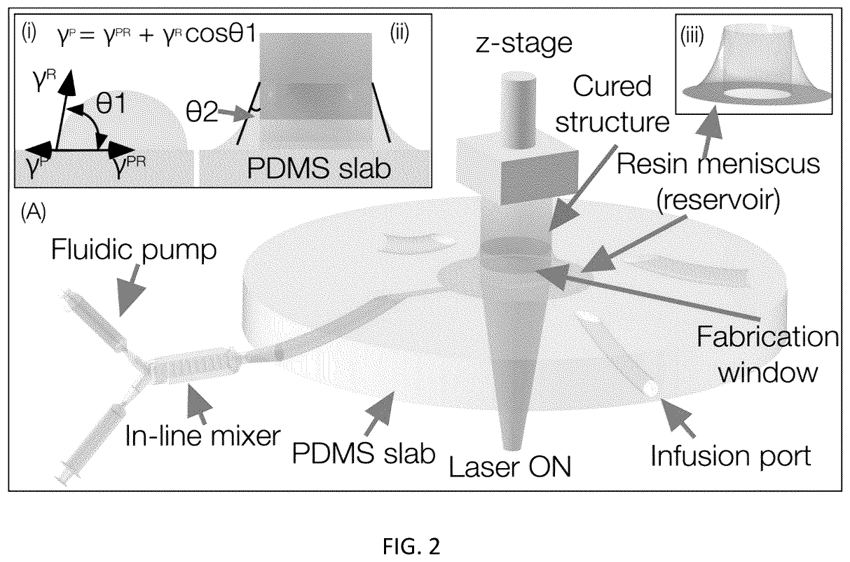

During printing, 405 nm light is spatially modulated via a digital micromirror device and projected through an oxygen-permeable and transparent PDMS bottom window to enable crosslinking in a layer-by-layer manner, as seen in FIG. 2. Vertical stage movement generates a suction force that continuously draws the photopolymer toward the fabrication window and acts against the adhesion interface force between the liquid resin/PDMS surface and the adhesion force between the liquid resin/crosslinked resin. The generation of a polymerization inhibition ‘dead zone’ just above the fabrication window enables defined separation between crosslinked layers and PDMS bottom substrate, as seen in FIG. 1A.

Printing with different resins required different light dosage (intensity×exposure time) that modulates curing depth and adequate dead-zone thickness to prevent the adhesion of newly crosslinked layers to the bottom PDMS window. In the present invention, the exposure times we modulated to enable reliable printing in a layer-by-layer manner. Based on the desired layer thickness and resin properties, light exposure times and z-stage movements can be programmed. The z-stage movement involves a step-up-down approach. For instance, to print one layer, the z-stage can move by 200 μm and draw adequate solution in the fabrication window, and then moves down by 150 μm to print with a layer-thickness of 50 μm, as seen in FIG. 1B(i-iv)).

Next, the resolution of MAPS is studied as the resolution is a critical factor that determines the quality of printed structures. In this study, the lateral (xy) and axial (z) resolutions of the MAP printing system was investigated using PEGDA 400 photopolymer as seen in FIG. 1C,D). The lateral resolution, which is the smallest feature size corresponding to 10.05±0.7 μm was achieved that closely corresponds to the theoretical resolution determined by an individual mirror's size (10 μm) of DMD. In order to improve the z-resolution of the printing, ITX was used as a photo absorber. Although the photosensitizer efficiency of ITX in acrylate-based resin is low, our study primarily employed ITX to restrict the penetration depth of the light and achieve the desired curing depth. With exposure times ranging from 0.5 to 2 seconds, a z-resolution of 42.79±1.12 μm was observed, while the curing depth varied from 42.79±1.12 μm to 122.24±4.45 μm.

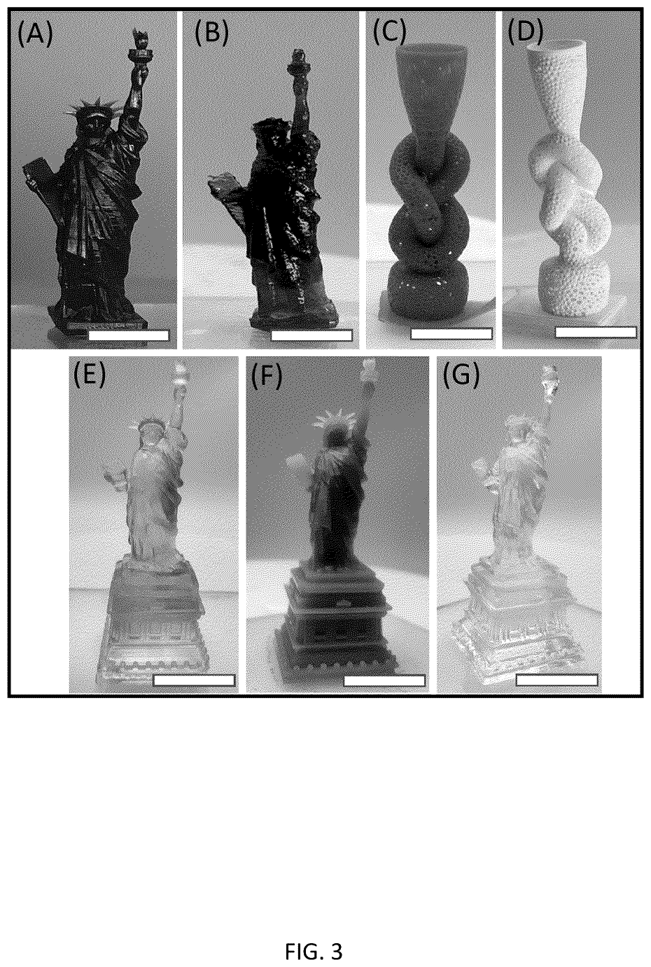

The optimized exposure conditions from the resolution studies were utilized to print a complex lattice cube using the MAPS printing technique as seen in FIG. 1E. The cube was printed with PEGDA 400 MW, 1% ITX photo absorber, and 0.25% Irgacure photoinitiator, with a layer thickness of 50 μm. Each layer was printed with a laser intensity of 3.25 mW/cm² and an exposure time of 0.7 seconds, and the structure was washed and developed by immersing it in an ethanol solution. Furthermore, a Statue of Liberty structure was printed using PEGDA 400 with the same parameters used for the cube as seen in FIG. 1F. These structures effectively demonstrate the capability of MAPS to produce complex structures with undercuts and overhangs. Further, the compatibility of MAPS printing was tested with different commercially available resins as seen in FIG. 3. The information regarding material formulation, optimized laser intensity, and exposure time for all resins used in this study can be found in Table 1 below:

TABLE 1
Photopolymer formulation, optimized laser intensity, exposure time and viscosity

| | | | | | | | Stage | Stage |
|---|---|---|---|---|---|---|---|---|
| | | | | | Exposure | | upward | downward |
| | | Photo- | UV | Intensity | time | Viscosity | movement | movement |
| | Resin | initiator | absorber | (mW/cm²) | (seconds) | (cps) | (μm) | (μm) |
| 1 | 7.5% | 1% LAP | — | 4.4 | 1 | 1.38 | 200 | 150 |
| | GelMA | | | | | | | |
| 2 | 50% | 1% LAP | 0.1% | 4.4 | 1.3 | 8.16 | 200 | 150 |
| | PEGDA | | tartrazine | | | | | |
| | 700 | | | | | | | |
| 3 | PEGDA | 1% LAP | 0.1% | 4.4 | 2.8 | 3.98 | 200 | 150 |
| | 6k | | tartrazine | | | | | |
| 4 | PEGDA | 0.25% | 0.5% | 4.4 | 0.8 | 25 | 200 | 150 |
| | 250 | Irgacure | ITX | | | | | |
| 5 | PEGDA | 0.25% | 0.5% | 3.25 | 0.7 | 57 | 200 | 150 |
| | 400 | Irgacure | ITX | | | | | |
| 6 | B9Creations | — | — | 4.4 | 2.5 | 300 | 500 | 450 |
| | Black | | | | | | | |
| | resin | | | | | | | |
| 7 | Liqcreate | — | — | 4.4 | 3 | 950 | 500 | 450 |
| | Flexible - | | | | | | | |
| | X | | | | | | | |
| 8 | Liqcreate | — | — | 4.4 | 3 | 1400 | 500 | 450 |
| | Composite - | | | | | | | |
| | X | | | | | | | |
| 9 | PhotoCentric | — | — | 4.4 | 2 | 230 | 500 | 450 |
| | 3D | | | | | | | |
| | Grey resin | | | | | | | |
| 10 | Siraya | — | — | 4.4 | 1.25 | 675 | 500 | 150 |
| | Tech Blu | | | | | | | |
| 11 | Siraya | — | — | 4.4 | 1.25 | 549 | 500 | 150 |
| | Tech | | | | | | | |
| | Sculpt | | | | | | | |
| 12 | eSUN | — | — | 4.4 | 2.75 | 2536 | 1000 | 950 |
| | eResin- | | | | | | | |
| | Elastic | | | | | | | |

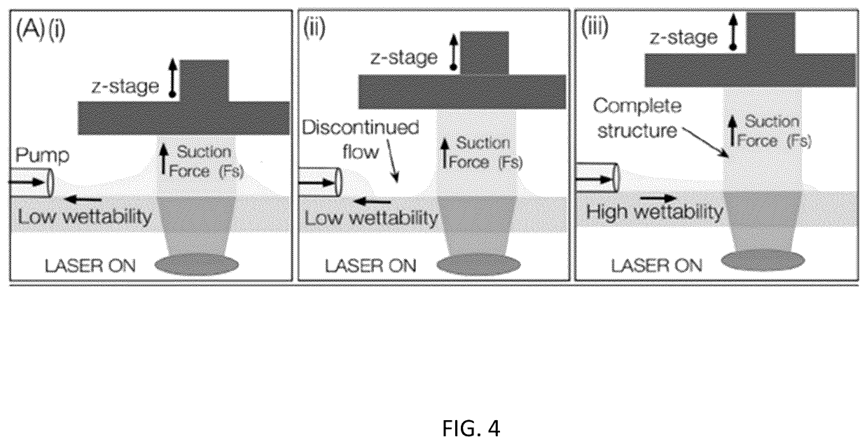

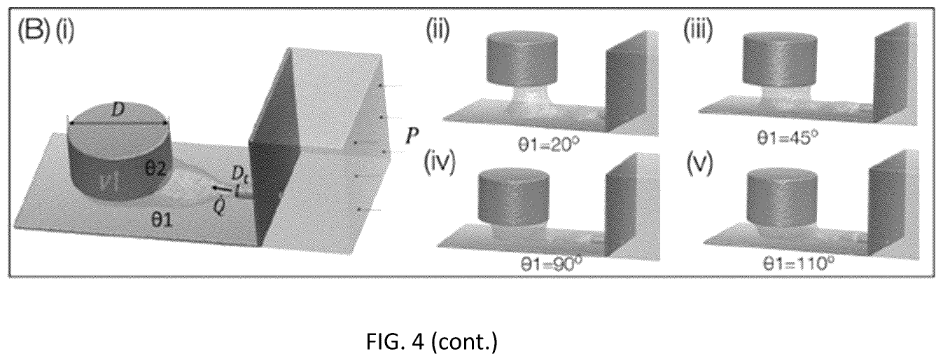

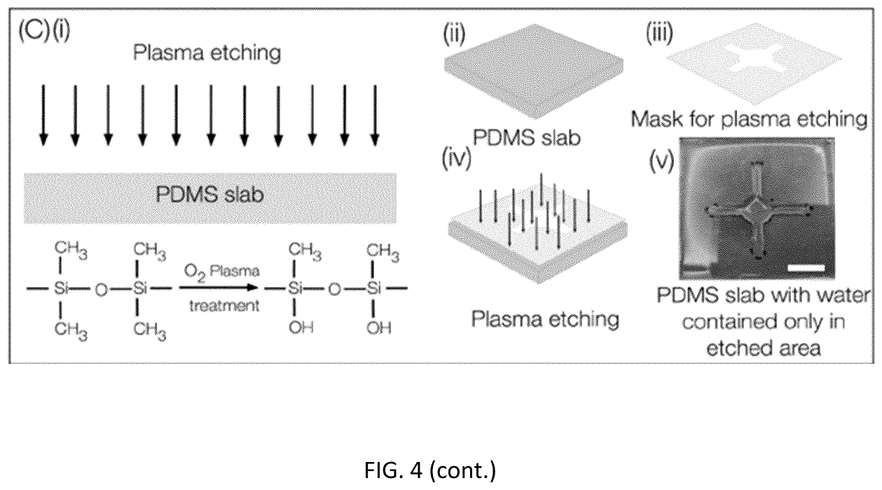

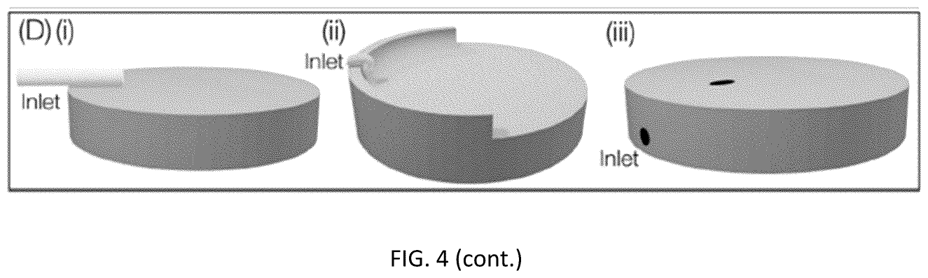

Maintaining meticulous control over the flow rate and small meniscus volume is crucial for achieving successful multi-material and gradient 3D printing using MAPS (FIG. 4A). To ensure a smooth printing process, it is important to monitor the fluidic pump flow rate, preventing any interruptions in the flow. The flow rate should be adjusted to a level that surpasses the resistance offered by the PDMS surface. Otherwise, the resin will accumulate at the opening of the infusion port, leading to the interruption of the flow (FIG. 4A(i, ii)).

To avoid cross-contamination during resin exchanges, a minimum volume of resin should be present in the meniscus; higher volumes lead to undesired mixing of resins. Ideally, the volume of resin in the meniscus should match the amount of resin required to print a single layer of the structure. This ensures a consistent composition of the resin throughout the printed structure, resulting in a high-quality final product. Therefore, careful control of the flow rate and meniscus volume is crucial to achieving successful multi-material and gradient 3D printing using MAPS.

Maintaining a delicate balance between flow rate and volume is crucial, as a higher flow rate can cause an increase in the resin volume within the meniscus. However, it is challenging to manage this balance due to the high flow rate required to overcome PDMS film resistance, which contributes to an undesired increase in resin volume and potential mixing issues. Additionally, achieving a matching infusion rate of new resin to resin consumption becomes even more challenging during multi-material and gradient printing, as the properties of the resin formulation, such as surface tension and viscosity, continuously vary throughout the process.

To address this challenge, a multiphase many-body dissipative particle dynamics (mDPD) model was used to simulate the dynamic process of droplet-based 3D printing with a system setup shown in as seen in FIG. 4B. Here fabrication window of PDMS, resin viscosity of 17.41 mPa·s with printhead size (D=5 mm) and infusion port (Dt=0.5 mm) was used.

The multiphase simulation results are depicted for different substrate wetting contact angle (θ1=20°) in (as seen in FIG. 4B(ii)), (θ1=45°) in FIG. 4B(iii), (θ1=90°) in FIG. 4B(iv) and (θ1=110°) in FIG. 4B(v). Simulation results showed that when the substrate becomes more hydrophilic, liquid adhesion is increased, resulting in the spreading of the droplet onto a wider wetting area. On the other hand, increased hydrophobicity of the substrate (θ1=110°) weakens liquid adhesion and makes it more susceptible to liquid-bridge breakage at a location between the printhead and pump outlet. The results obtained from multiphase fluid simulations provided valuable insight into the underlying physics of multiphase flow and droplet wetting. By visualizing and analyzing the multiphase flow dynamics, a contact angle between 30° to 45° was identified as an optimized contact angle suitable for multi-material and gradient printing.

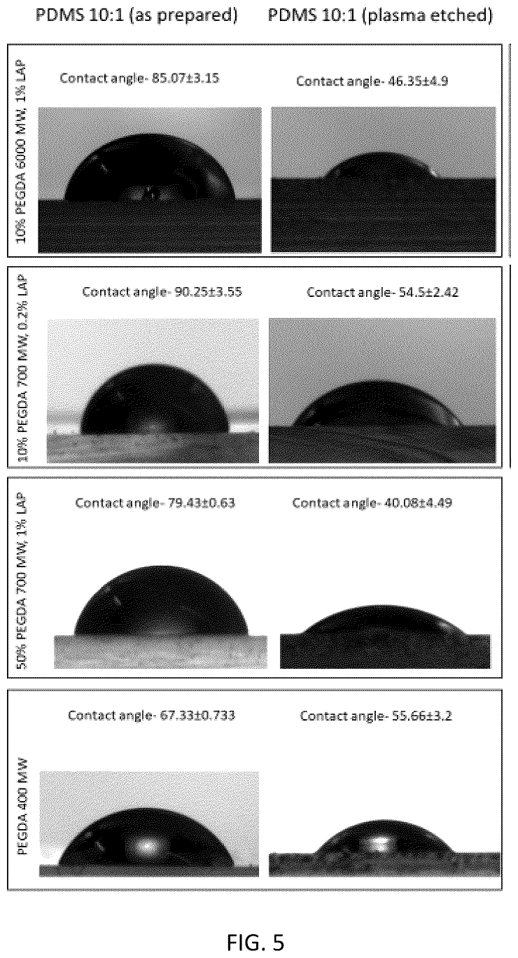

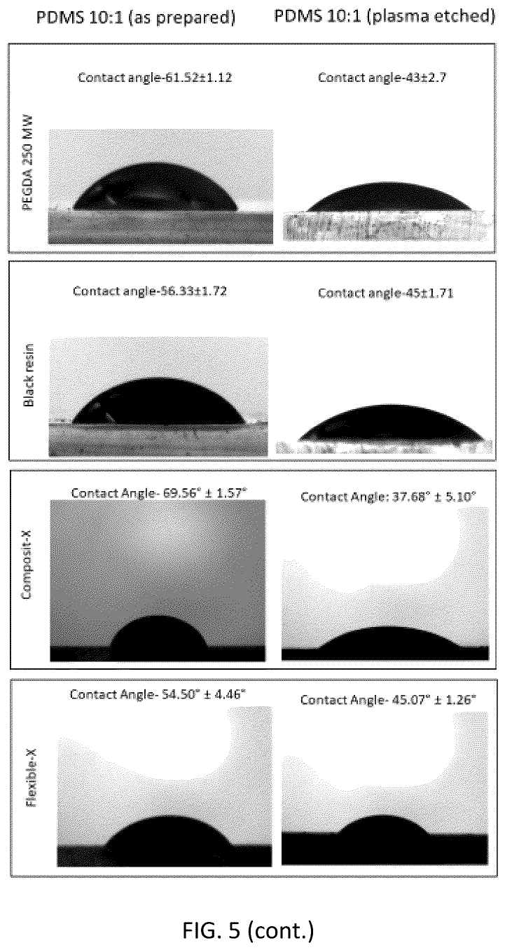

To achieve the desired contact angle range, plasma etching was used to selectively pattern the low surface energy area (high wettability) on PDMS bottom window to enable continuous yet low-volume flow of resin from infusion port to the fabrication area as seen in FIG. 4C (i-iv). Briefly, plasma etching (5 minutes; RF power-75 W) was used to pattern a cross-shaped higher wettability pattern to facilitate low-volume resin flow from 4 independent infusion ports towards the fabrication area. The contact angle of patterned areas showed a decrease of 20-40° for all the polymers tested as seen in FIG. 5. MAPS using plasma-etched flow paths allowed the printing process to draw liquid resins from a greater distance and led to multi-material and gradient structures with minimal cross-contamination.

Three distinct sample holder configurations were employed for photopolymer flow as seen in FIG. 4D(iii). The first configuration involved a side tube design, which exhibited instances of liquid polymer flowing backward along the outer wall of the tube. In contrast, the second configuration utilized a top tube design, and the third configuration featured a side channel design with a slanting angle. Both latter configurations performed well without any issues.

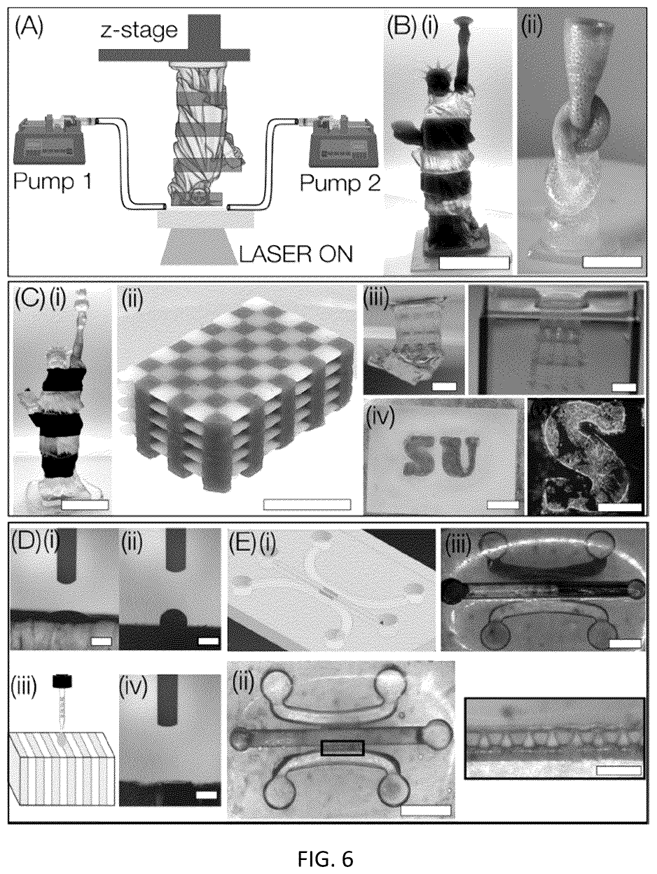

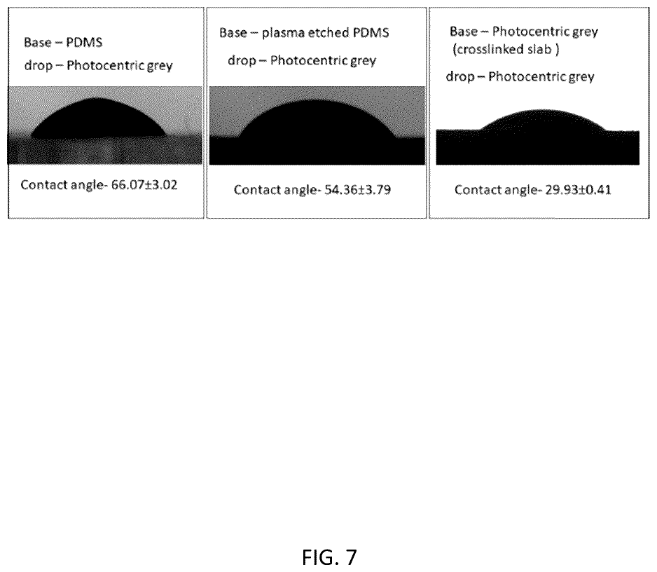

Multi-material printing using MAPS. Here, the versatility of MAPS printing was demonstrated by designing and printing a variety of multi-material structures using two independent infusion ports connected to programmable syringe pumps as seen in FIG. 6A. For instance, PEGDA 250 MW and Photocentric grey resin were used to print ‘The Statue of Liberty’ (as seen in FIG. 6B (i), and a knotted vessel (as seen in FIG. 6B(ii)). MAPS system with flat multi-port configuration with adjustable flow rates also allows easy material exchange and facilitates multi-material printing in the lateral (XY) directions. For instance, FIG. 6C (i) shows another ‘Statue of Liberty’ geometry where rapid cleaning steps were performed between exchanges of PEGDA and Black resin to ensure no contamination between layers. An array of 3D pillars with a checkerboard roof pattern demonstrates the combined lateral and vertical multi-material printing capabilities of MAPS as seen in FIG. 6C(ii).

Next, a 3D log pile structure was printed using PEGDA 700 and PEGDA 6k (as seen in FIG. 6C(iii)). PEGDA 700 resin yielded 3D structures with sharp edges and firm mechanical properties, while PEGDA 6k resin produced softer and less distinct structures. The soft section of the construct was unable to maintain its mechanical stability in the air, its unique mechanical architecture became visible upon immersion in water. Then, two biocompatible materials (PEGDA 6k and GelMA) were printed on top of each other to show selective cell adhesion to GelMA that possesses cell binding sites as compared to inert PEGDA 6k. Syracuse University logo, printed with GelMA on top of a flat PEGDA 6k slab shows cell attachment and spreading of human osteosarcoma cells (Saos-2) on Day 7, and minimal-to-no cell attachment on underlying inert PEGDA 6k slab as seen in FIG. 6C(iv).

To demonstrate the fabrication of hydrophobic and hydrophilic materials using MAPS, alternate layers of hydrophobic and hydrophilic material were printed and the contact angle that water forms on the surface of the printed slab studied as seen in FIG. 6D. Water forms a small contact angle when a water drop is deposited on the slab printed using PEGDA 6k whereas, as expected, the contact angle is higher for PEGDA 250 slab as seen in FIG. 6D(i-ii). For the structure printed with alternate PEGDA 250/PEGDA 6k base, the water drop travels out-of-focus along the hydrophilic line pattern as seen in FIG. 6D(iii-iv).

Lastly, a three-chambered microfluidic device separated by micropost arrays was printed with central ‘hydrophilic’ (PEGDA 6k) channel and flanked by two ‘hydrophobic’ (PEGDA 250) channels was printed using MAPS as shown in FIG. 6E(i-iii). Results show that green dye mixed in DI water remains within the central channel as compared to an identical device printed only with PEGDA 6k MW (hydrophilic) resin. This approach can be useful for organ-on-a-chip applications. This approach demonstrates the effectiveness of multi-material printing in overcoming flow control challenges and improving the functionality of microfluidic cell culture systems. Overall, this advanced fabrication process demonstrates the potential for creating complex, multi-material structures with a high degree of precision and control.

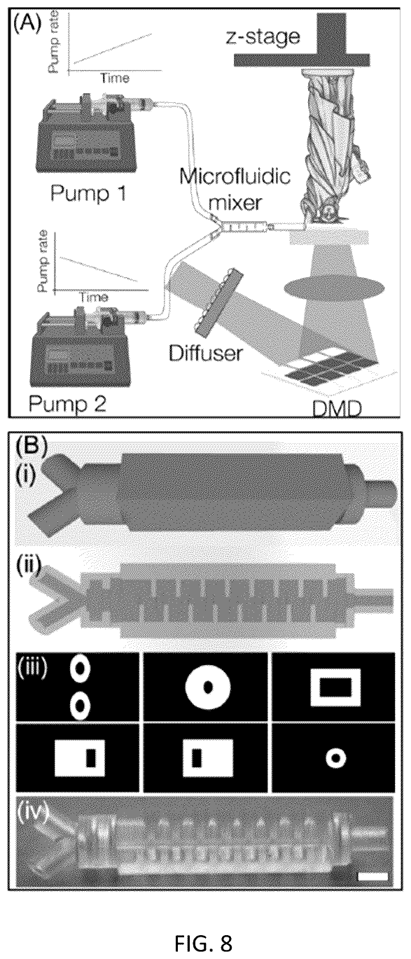

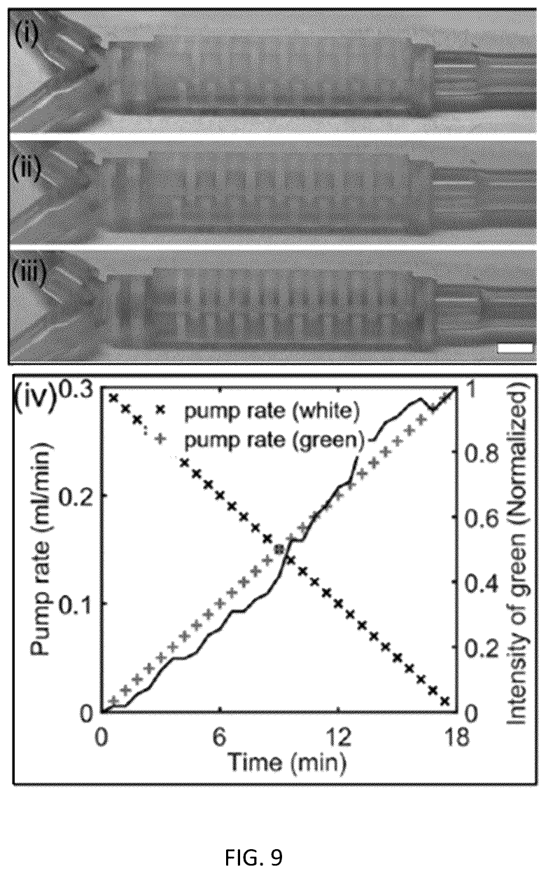

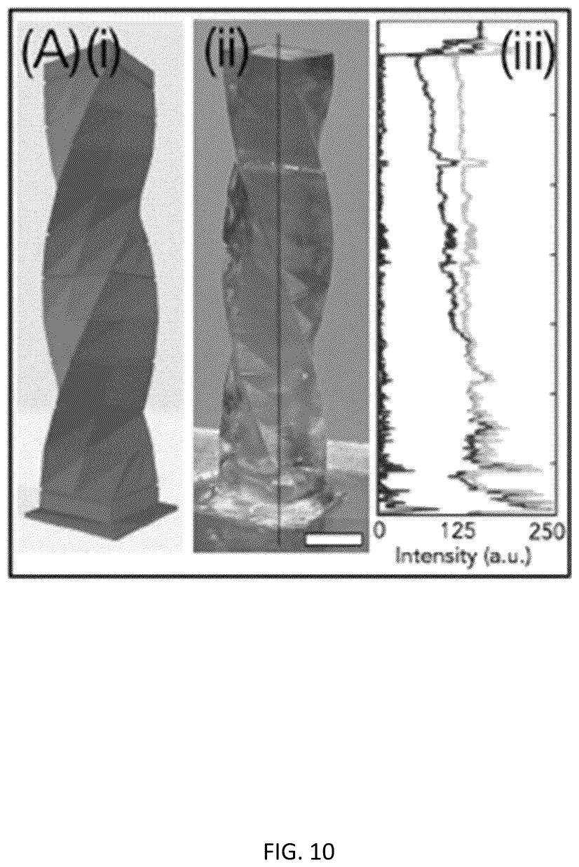

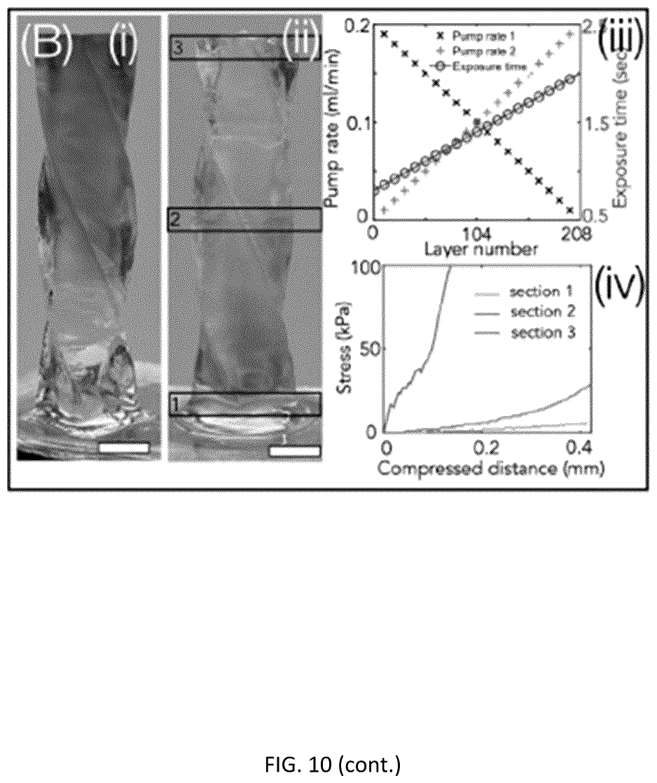

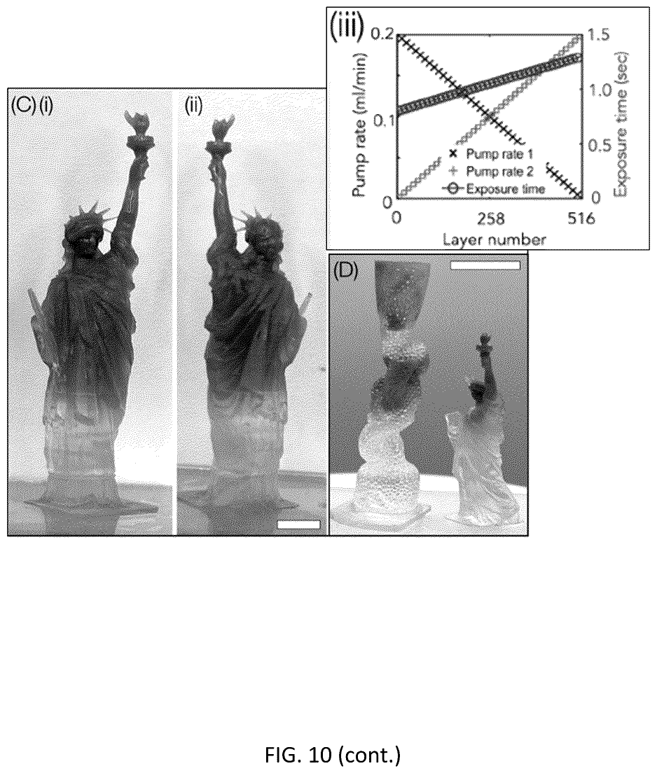

Gradient printing using MAPS. MAPS-printed inline micromixer connected to multiple programmable perfusion pumps was integrated within the system to print complex structures with defined gradients as seen in FIG. 8A. Details related to the design, fabrication, and performance characterization of the micromixer are provided in FIGS. 8 and 9. Based on the desired gradient properties, multiple photopolymer solutions were mixed at defined flow rates and concentrations to generate droplets within the fabrication area. During the MAPS process, laser exposure times per layer were modulated based on the crosslinking requirements of the solution mixtures to obtain a uniform curing depth. The capabilities of printing gradient complex 3D structures were assessed using a range of structures, materials, and configurations. For instance, ‘twisted tower’ with a defined color gradient was printed with PEGDA 700 as seen in FIG. 10A (i-ii)). RGB intensity shows significant differences on the top (green) of the tower while a mixture of red and green mix to generate yellow color at the bottom of the structure as seen in FIG. 10A(iii). A combined mechanical and color gradient ‘Twisted tower’ structure was also printed using PEGDA 700 (brown, stiff) and PEGDA 6k (colorless, soft) with flow rates varying between 0-0.2 ml/min for both resins in the opposite direction and at the same time the exposure time from 0.8-2 seconds to obtain identical curing depth per layer despite changes in the droplet formulations as seen in FIG. 10B(i). Next, the same structure was printed by reversing the flow rate of the two photopolymers to generate mechanical and color gradients in opposite directions as seen in FIG. 10B(ii). To assess the mechanical properties of the structure at different sections (400 μm), marked by black boxes in FIG. 10B(ii), the structure was sectioned using a sharp scalpel, and a compression test was performed. The compression test revealed that the modulus of compression elasticity was highest for the bottom section of the structure (3.9 MPa), where the flow rate for PEGDA 700 was the highest. Conversely, the modulus was lowest for the top section where the structure is soft (249 kPa). Results show a programmable method to generate customized 3D geometries with multiple gradient properties (color and mechanical stiffness). To further demonstrate the use of MAPS with commercially available resins, gradient ‘Statue of Liberty’ structures were printed using a combination of PEGDA 250 MW (colorless) and photocentric grey DLP resin by linearly varying flow rates (0-0.2 ml/min). Both front and back views of the printed structure are shown in FIG. 10C(i-iii). The same structure was also printed with exponentially varying flow rates. Additionally, a ‘knotted vase’ structure was printed using the same two materials, but with different inlet ports as seen in FIG. 10D. These results who the modular capabilities of MAPS for printing 3D geometries with user-defined gradient properties.

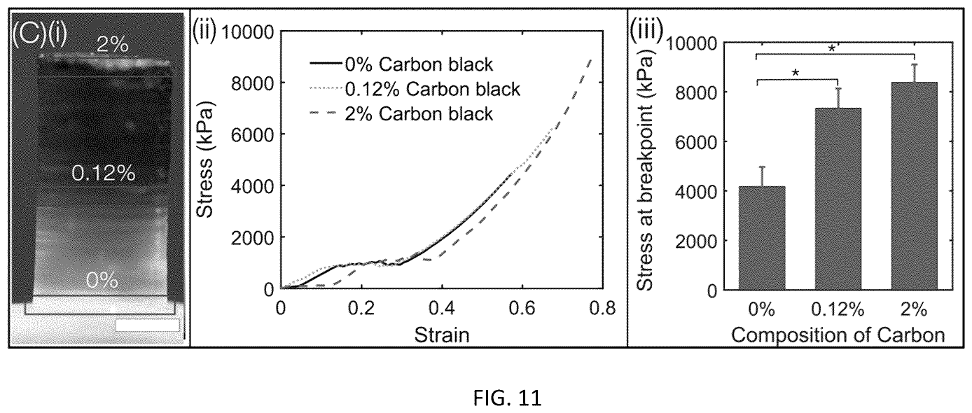

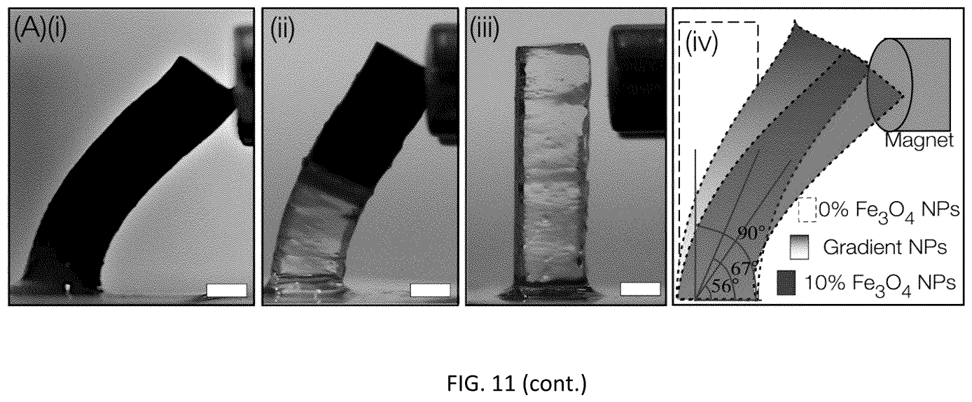

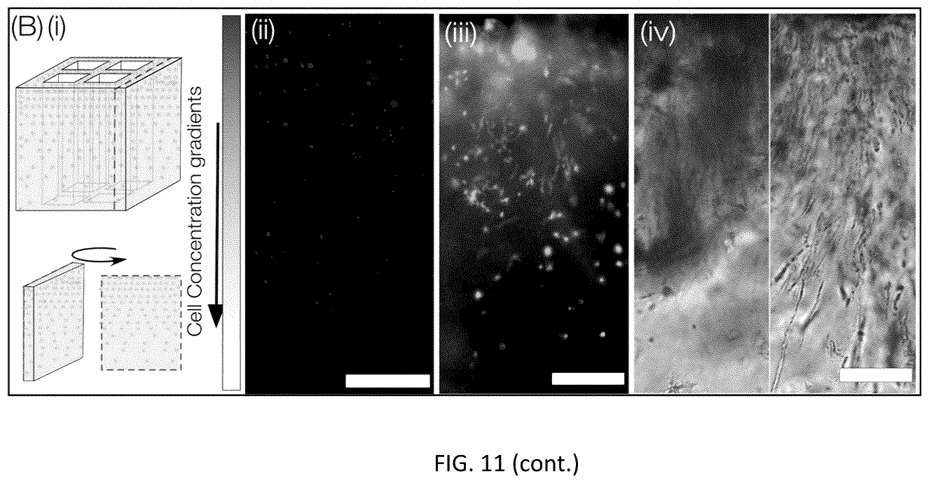

Gradient printing with nanomaterials and living cells. First, the printing of PEGDA 700 MW hydrogel with a gradient distribution of carbon black was demonstrated. Carbon black as an additive reinforces the mechanical properties of the structure. A cylindrical structure was printed using a PEGDA 700 MW with carbon black, where the concentration of carbon black varies from 0% to 2% as seen in FIG. 11A(i). Sections of the structure (marked by yellow rectangles) were compressed to obtain a compressive stress-strain plot, which provides a clear indication of the gradient and enhanced mechanical properties of the printed structure as shown in FIG. 11B(ii). Further, a bar diagram as depicted in FIG. 11B(iii) shows the amount of stress required to break different sections of the structure. The section containing 2 wt % carbon black required a stress of 8385±719 kPa to break, whereas the stress required for the section with 0.12 wt % decreased to 7339±793 kPa. In contrast, the section without any carbon black required a stress of almost 4174±793 kPa to break. The variation in the stress required to break the different structures with varying amounts of carbon black provides valuable insights into the mechanical properties of the printed gradient structure.

Next, a solution of iron oxide magnetic nanoparticles (NPs) mixed in water was added to 10% PEGDA 6k to allow sufficient curing depth of the mixed resin solution. For instance, MAPS printing with light intensity of 3.25 mW/cm² resulted in a curing depth of 120 μm for resin with 10% NPs and an exposure time per layer of 25 seconds, as compared to a curing depth of 150 μm and an exposure time of 1.5 seconds for only resin. Optimized parameters were used to print a cylindrical geometry with a gradient structure with a maximum concentration of 10% NPs in the top section and decreasing NP concentration along the length of the cylinder. This was achieved by dynamically modulating the exposure times from 25 to 1.5 seconds Results show that only the structures with NPs respond to the magnetic field, and the response of the gradient-aligned NPs structure was distinct from that of the structure with uniform NP distribution as seen in FIG. 11B (i-iii). The ability to incorporate other functional NPs in customized gradient configurations can be broadly applied to many applications ranging from structural colors, soft robotics, and photonics to name a few.

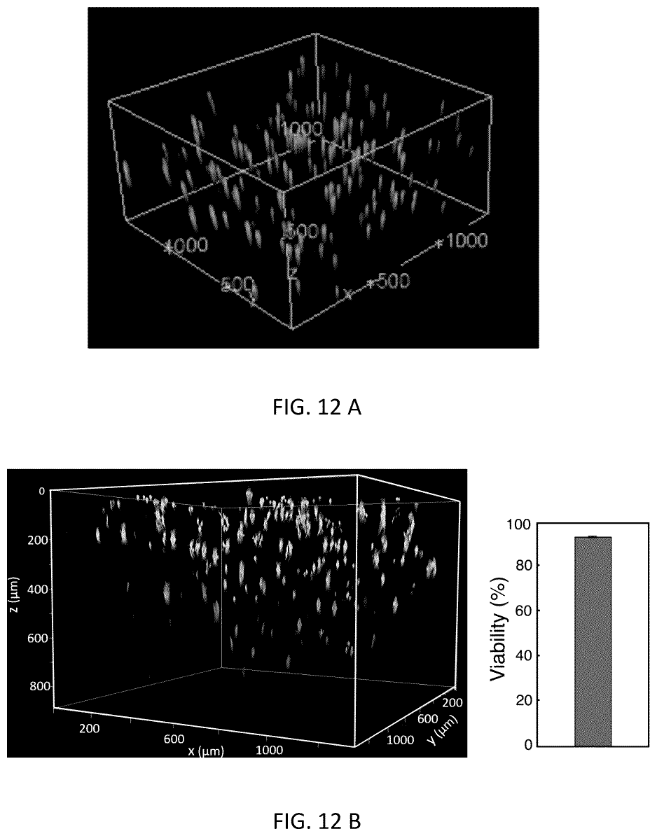

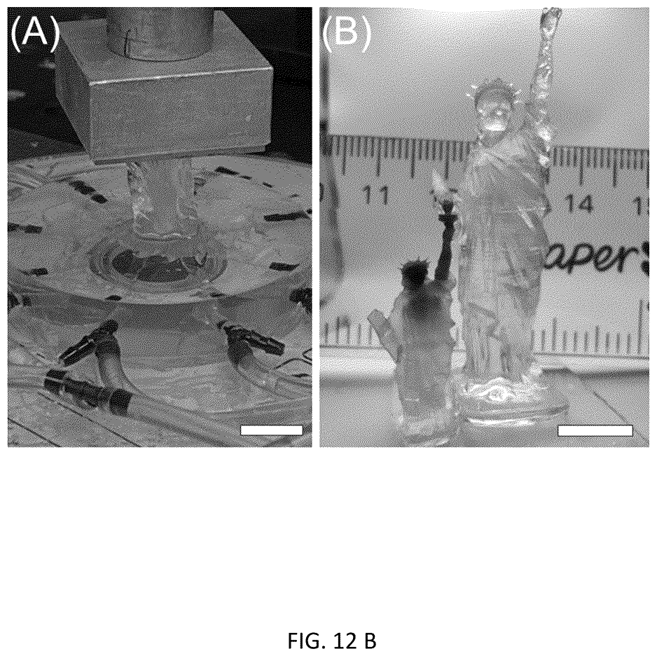

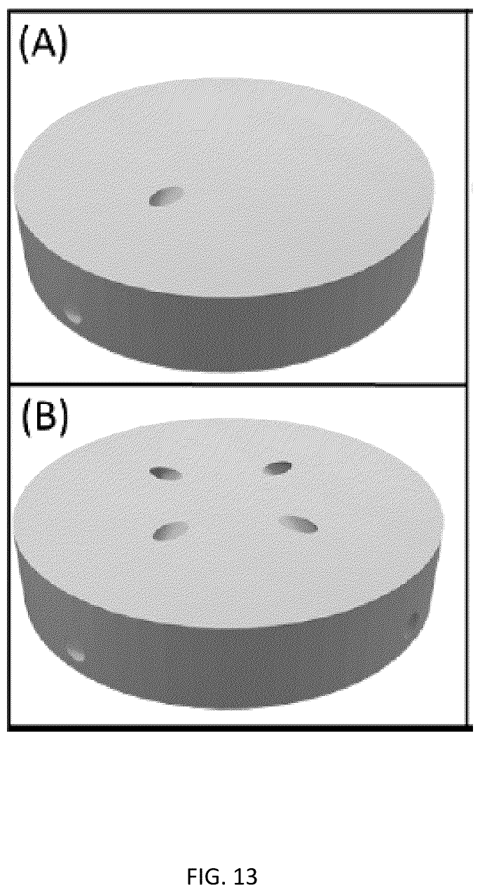

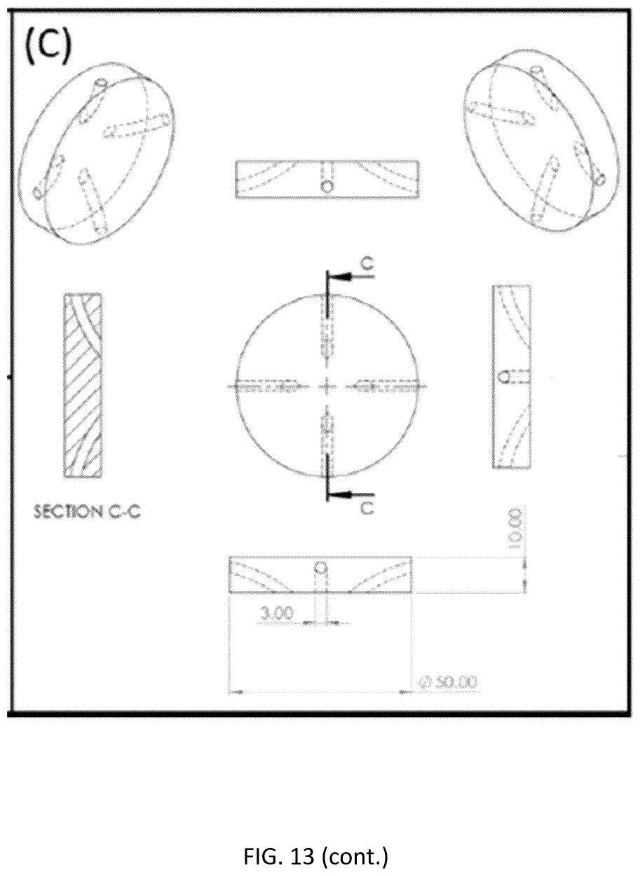

To demonstrate that MAPS can be also used for bioprinting applications, a 3D geometry with a gradient of cell density was printed using a bioink composed of 7.5% GelMA, 10% PEGDA 6k, and 0.25% LAP. Similar bio-ink formulations have been used widely in the field. Before gradient bioprinting, printing conditions were optimized using model fibroblasts (C3H10 10T1/2s, 1M/ml). Result shows a high cell viability and uniform cell distribution throughout the construct as seen in FIG. 12. Optimized conditions (laser power: 3.6 mW/cm²; exposure time: 1 seconds/layer; layer thickness: 50 μm) were used to bioprint a 3D structure with gradient densities of MC3T3 (pre-osteoblasts, 1 M/ml) along the Z-direction (from top to bottom) as seen in FIG. 11C. Post-printing, the sample was washed with PBS 3×, sliced into half, and stained for nuclei (DAPI) as seen in FIG. 11C(ii). On Day 7, Live/Dead assay was performed on sliced samples, and fluorescence images revealed a gradient of live cells (green) with high spreading on the top section and no dead (red) cells as seen FIG. 11C(iii). The printed sample was cultured under osteogenic media for 14 days and stained with Alizarin Red to identify regions of mineral formation. Results show a gradient of mineralization from the top to the bottom section of the printed sample as seen in FIG. 11C (iv). These results show a proof-of-concept of printing tissue models with customized control over cell densities.

### Methods

### Chemical

The present invention employed various photopolymers, each with a specific composition and preparation method:
(1) GelMA prepolymer solutions with 7.5% w/w were created by dissolving the required dry macromer mass in Millipore water with 1.0% (w/w) LAP.
(2) PEGDA (700 MW; Sigma Aldrich) solution was formed by dissolving 100% solid macromer in its waxy form in millipore water, resulting in 20% w/w with 0.2% LAP (w/w).
(3) PEGDA (6000 MW) was synthesized in the laboratory and dissolved in water to achieve 10% w/w PEGDA 6k, with 1% LAP w/w. In all (1-3) photopolymers, Tartrazine was used as a photo absorber in a concentration of 10% of LAP (w/w). The solutions were usually vortexed and degassed overnight at 37 °C before use.
(4) PEGDA solution (MW 250; Sigma Aldrich) was added with 0.5% ITX and 0.25% Irgacure w/w and used without dilution.
(5) PEGDA solutions (MW 400; Sigma Aldrich) were prepared by adding the purchased product to a final concentration of 100%, with 0.5% ITX and 0.25% Irgacure. Both PEGDA solutions were vortexed and degassed before use.
(6) Commercial resins. A Black resin (B9Creations), Flexible-X resin and Composite-X resin (Liqcreate), Blu resin and Sculpt resin (Siraya Tech), eResin-Elastic resin (eSUN), and PhotoCentric 3D grey resin (MatterHackers), were used without further modification.

### Optical Fabrication

In FIG. 2, a comprehensive diagram of the MAPS for generating 3D structures is displayed. This approach employs a layer-by-layer additive mode of fabrication, utilizing a 405 nm laser source (Toptica) that can generate a continuous-wave (CW) laser beam with a maximum power output of 300 mW. To collimate and expand the laser beam, a shutter (SI-105) is positioned after the laser source, and a 4f-transfer lens assembly (f=40 mm and 200 mm) is utilized. The laser beam is spatially filtered through a 25 μm pinhole, which is then directed through a diffuser (RPC Photonics Inc) to transform the Gaussian intensity distribution of the laser beam to a uniform distribution. The diffuser is mounted on a rotating mount to minimize the laser speckle generated by the diffuser. The laser beam is collimated and directed towards a Digital Micromirror Device (DMD) (0.95″ 1080p UV DMD, DLi Inc), which is an array of micromirrors that can be modulated to spatially pattern laser beams. The patterned laser beam is projected onto infinity-corrected projection optics, which includes two lens systems (f 300 mm and f=300 mm at a distance of 60 cm). A precisely adjusted distance between the lenses can focus the spatially patterned on the fabrication window.

The PDMS slab, L-shaped stage and fluidic pumps schematic are displayed in FIG. 1. The PDMS slab, is positioned above a heater (WP-16 Warner instrument) that has a hole in the center. The heater is used to warm the PDMS membrane to 40 °C for GelMA printing, as this hydrogel gels below 37 °C. The L-shaped stage and its movement are controlled using a three-dimensional linear stage PI. A custom Lab VIEW code was used to coordinate the alteration of the mask in the DMD with the movement of the stage in the z-direction. Additionally, two microfluidic pumps from New Era Pump Systems Inc. and a custom-designed microfluidic mixer were employed to provide a continuous supply of prepolymer solution. The SyringepumpproV1 software was utilized to program the fluidic pumps for the printing of multipe materials and gradients structures.

The process of creating a 3D structure involves several steps. First, a CAD model is designed in Illustrator or Solid design software. Next, Matlab code is used to slice the 3D structure into 2D png images to generate a digital mask that corresponds to individual printing layers. Each image is then processed with a MATLAB code to create a 1-bit image with the desired spatial distribution for its unique 2D slice. These images are fed into a custom-written Lab VIEW code that synchronizes the pump flow rate, volume, upward movement of the stage, and exposure of the light pattern generated by DMD. This process ensures precise control over the printing of each layer of the 3D structure.

Further, the CAD design and dimensions of the single-channel and four-channel sample holder with side channel configuration are depicted as seen in FIG. 14(A-C).

### Optical Characterization

The 3D structures created were analyzed and imaged using a digital optical microscope (HIROX, KH-8700). For imaging, the MXG-2016Z/MX-2016Z 20-160× objective lens was utilized, providing a resolution of 1.35 μm. Fluorescence images were obtained using Leica DMI4000B inverted microscope. Images and Videos were also recorded using a DSLR camera (Cannon EOS T6i).

### Mechanical Characterization

The compression test was conducted at room temperature using an Instron Universal Testing System (Model-5966). Sections of gradient structures were sliced and compressed at a rate of 0.5 mm/min.

### Plasma Etching Process

Plasma etching was done using Oxygen gas as the etchant in the plasma machine from Plasma etch Inc. The plasma etching process was performed for 5 minutes at RF power of 75 W.

Cell culture. The C3H10 (10T1/2s) cell line is derived from C3H mouse embryo cells and is characterized by fibroblast cell morphology. These cells were cultured in T75 vented culture flasks with Basal Medium Eagle (BME) supplemented with 10% fetal bovine serum (FBS), 1% penicillin/streptomycin, and 1% Gibco GlutaMAX. The cells were harvested using trypsinization before reaching full confluency, and after centrifugation at 125 g for 5 minutes, the cells were counted using a Bio-Rad TC10 Automated Cell Counter. To achieve a final cell density of 1×106 cells/ml, the cells were homogeneously mixed with complete growth media.

The Saos-2 cell line is a type of osteosarcoma cell line. To maintain the cells in culture, a medium containing DMEM (Dulbecco's Modified Eagle's Medium) with high glucose and pyruvate was used. This medium is supplemented with 10% fetal bovine serum (FBS), 1% L-glutamine, and 1% penicillin-streptomycin, which provide the necessary nutrients and growth factors to support cell growth and survival.

Specifically, MC3T3 cells were cultured in a 175 cm2 flask until they reached 80% confluency, after which they were harvested. The cells were detached from the flask using trypsin and centrifuged to form a pellet. Subsequently, the pellet was resuspended in cell growth media to achieve a cell concentration of approximately 1 million cells per ml. The final cell suspension was loaded into a sterile syringe to prepare for the printing process.

### Live/Dead Assay

To assess the viability of cells in bioprinted structures, a Live/Dead assay was performed. Firstly, the bioprinted structure was washed with PBS, and then incubated in cell growth media containing 1:1000 dilution of calcein AM to stain the live cells, and 1:500 dilution of ethidium homodimer-1 to stain the dead cells. Following a 30-minute incubation period inside the cell incubator, the structure was washed and imaged using an inverted fluorescence microscope with a FITC filter set for live cells and an RFP filter set for dead cells.

### DAPI Staining

To perform DAPI staining on a bioprinted structure, the structure was washed multiple times in PBS before being fixed with 4% formaldehyde for 20 minutes at room temperature. Following fixation, the structure was washed again with PBS and then permeabilized with 0.2% Triton X-100 for 15 minutes at room temperature. The structure was then immunostained using a 1:1000 dilution of DAPI in PBS. The immunostained sample was imaged using an inverted fluorescence microscope with a DAPI filter set.

### EXAMPLE

### GelMA Synthesis

Gelatin Methacrylate (GelMA) macromer was synthesized following a previously reported protocol. In brief, 10 g of porcine skin gelatin (Sigma Aldrich, St. Louis, MO) was mixed in 200 ml of phosphate-buffered saline (PBS, Thermo Fisher Scientific) at 45 °C, and methacrylic anhydride was added to the solution, which was stirred for 3 hours. The resulting mixture was then dialyzed against distilled water for 1 week at 40 °C to remove any unreacted groups. The dialyzed GelMA was lyophilized in a freeze dryer (Labconco, Kansas City, MO) for one week. To prepare a 15% (w/v) GelMA stock solution, 1.5 g of freeze-dried GelMA was mixed with 10 ml of deionized water (dissolved at 40 °C), and 0.25% (w/v) UV photoinitiator lithium phenyl-2,4,6-trimethyl-benzoyl phosphinate (LAP) was added. The GelMA pre-polymer solution was then diluted using DI water to obtain either 7% or 10% GelMA, filtered (pore size-0.2 μm), and used within 2 hours after preparation.

### PEGDA 6k Synthesis

To synthesize PEGDA 6k, the first step involved preparing anhydrous dichloromethane (DCM) by refluxing it over calcium hydride for 2 hours, followed by simple distillation and storage over activated 3A molecular sieves. Next, 18 g of PEG 6k was dissolved in 300 mL of anhydrous DCM and cooled in an ice bath. Under a nitrogen blanket with stirring, 1.69 mL of triethylamine was added to the chilled solution, followed by the dropwise addition of a solution of 0.975 mL acryloyl chloride diluted to a final volume of 15 mL in anhydrous DCM via an addition funnel. The reaction mixture was allowed to stir for 30 minutes under a nitrogen blanket, and then allowed to proceed overnight with constant stirring in a covered flask under nitrogen. Afterward, the reaction mixture was vacuum-filtered through Celite 545, followed by washing of the Celite with three aliquots of DCM. The excess DCM was removed using a rotary evaporator until the concentrate became slightly cloudy. The concentrate was reconstituted with a minimal amount of fresh DCM to achieve a clear solution. PEGDA was then precipitated by dropwise addition to hexane with vigorous stirring. The resulting precipitate was isolated via vacuum filtration, washed with three aliquots of hexane, and then three aliquots of −80 °C diethyl ether. Finally, the washed PEGDA was dried under a vacuum at room temperature for two days.

### LAP Synthesis

Lithium phenyl-2,4,6-trimethyl-benzoyl phosphinate (LAP) was synthesized in two steps according to a published procedure. First, under argon at room temperature, 2,4,6-trimethyl benzoyl chloride (4.5 g, 25 mmol) was added dropwise to dimethyl phenyl phosphonate (4.2 g, 25 mmol) with continuous stirring. The reaction mixture was stirred for 24 hours, after which an excess of lithium bromide (2.4 g, 28 mmol) in 50 mL of 2-butanone was added to the reaction mixture. The mixture was then heated to 50 °C and allowed to stir for 10 minutes, resulting in the formation of a solid precipitate. After cooling the mixture to room temperature and letting it rest overnight, it was filtered and the filtrate was washed with 2-butanone (3×25 mL) to remove any unreacted lithium bromide. The resulting product was then dried under vacuum to yield LAP (6.2 g, 22 mmol, 88%) as a white solid.

### Surface Modification of Glass Substrate

To ensure adhesion of a crosslinked structure to the glass, glass coverslips (18 mm×18 mm, No. 2; Globe Scientific) were surface modified with a methacrylate function group. A cleaned coverslip was first treated in a Piranha solution (a mixture of sulfuric acid and hydrogen peroxide in a 7:3 ratio) for 20 minutes. The glass was then washed with MilliPore water and 100% ethanol (Fisher Scientific, Pittsburgh, PA), and dried using compressed air. To functionalize the coverslip, it was dipped in a bath containing 85 mM of 3-(trimethoxysilyl) propyl methacrylate (Fluka, St. Louis, MO) in ethanol with acetic acid (pH 4.5) overnight at room temperature. Finally, the coverslips were washed in 100% ethanol and dried. This process ensured that the coverslips had a methacrylate function group on the surface, allowing for strong adhesion of the crosslinked structure to the glass.

### Resolution

The resolution of 3D printing is a critical factor that determines the quality of printed structures. In this study, we investigated the lateral (xy) and axial (z) resolutions of our continuous MAP printing system, using PEGDA 400 photopolymer. These resolutions depend on several factors, including the printing system's light exposure conditions, z-direction displacement of the stage, and material properties such as transparency, monomer reactivity, radical diffusion, and photochemical efficiency. PEGDA 400 photopolymer is proven to provide high-resolution 3D printed structures. To determine the lateral resolution, we printed lines of varying widths (1-10 pixels) from a digital mask. The resulting array of lines with linewidths ranging from 10.05±0.7 μm to 109.42±0.54 μm is depicted (FIG. 1C (i, ii)). The smallest feature size (10 μm) was achieved using a 1-pixel line, which closely corresponds to the theoretical resolution determined by an individual mirror's size of DMD. We plotted the theoretical feature size against the experimental linewidth of the structures printed with a laser intensity of 3.25 mW/cm² and exposure time of 1 second, which showed good agreement between theory and experiment.

The axial resolution, or z-direction resolution, depends largely on the curing depth, which is the thickness of the cross-linked layer in relation to the irradiation dose. The curing depth is affected by the z-direction motion of the stage, photopolymer optical absorbance, and crosslinking kinetics. Excessive light penetration beyond the desired curing depth results in unwanted crosslinking, leading to artifacts, particularly while printing channels, undercuts, and overcuts. To address this issue, we aimed to decrease the curing depth by increasing the photopolymer's absorbance using various methods, such as adjusting light dosage and using photo absorbers like Tartrazine, Sudan, and TINUVIN. In this study, we used ITX as a photo absorber, which also acts as a photosensitizer. However, ITX's photosensitizer efficiency in acrylate-based resin is low, so the primary role of ITX in our study was to limit the light's penetration depth to achieve the desired curing depth. We printed a ladder structure with varying exposure times from 0.5 to 2 seconds while maintaining a constant exposure intensity of 3.25 mW/cm² as seen in FIG. 1D (i,ii) 1D (i-ii)). Our results showed that the z-resolution of 42.79±1.12 μm while the curing depth varied between 42.79±1.12 μm to 122.24±4.45 μm for an exposure time range of 0.5 to 2 seconds.

### Microfluidic Mixer

Before printing the gradient structure, a microfluidic mixer was designed and printed using MAPS to obtain the mixing of material with the desired composition as seen in FIG. 8B. The micromixer was designed using solid works and the mixer consists of two inlets, an outlet, and mixing architecture elements. The architectural element of the mixer consisted of the chambers connected with alternating up and down the channel of 500 μm inside the cubic reservoir of 2 mm. This homogenized the prepolymer solutions because of interactions between fluid flow and the element geometry as seen in FIG. 8B(i,ii). A custom-written Matlab code was used to slice the micromixer CAD design and converted it to a computer-generated digital mask as seen in FIG. 8B(iii). The digital masks were fed to DMD to pattern the light to print the mixer using PEGDA 250 photopolymer as seen in FIG. 8B(iv).

In order to observe the rapid mixing of hydrogels, a flow stream of two colored PEGDA hydrogels was applied from two inlets, and the fluid passing through the mixing architecture elements was observed. The results, which are presented in FIG. 9 demonstrate the rapid mixing of the hydrogels. By adjusting the relative flow rates of the two inks, the desired concentration profile can be programmed into the fluidic pumps. FIG. 9(i-iii) illustrates an example of the flow of green-colored PEGDA 700 MW hydrogel and milky white-colored PEGDA 700 MW photopolymer. In this case, the pump flow rate for the white-colored PEGDA linearly decreased from 0.3 ml/min to 0 ml/min over a period of 18 minutes, while the pump flow rate for the green-colored PEGDA was reversed. The intensity of the green dye in the mixture was recorded at the outlet, which showed a linear increase over time, indicating the excellent mixing capabilities of the micromixer as seen in FIG. 9(iv).

What is claimed is:

1. A system for performing projection stereolithography, comprising:
a z-stage capable of movement along a vertical axis;
a transparent substrate positioned below and spaced apart from the Z-stage;
a first continuous flow pump positioned to deliver a first amount of resin onto the transparent substrate;
a source of illumination positioned below the transparent substrate and oriented to direct illumination through the transparent substrate; and
wherein the z-stage is capable of movement along the vertical axis during operation of the first continuous flow pump at a rate to form a meniscus in the amount of resin between the transparent substrate and the z-stage and to maintain the meniscus when the source of illumination is operated to cure of a portion of the amount of resin.

2. The system of claim 1, further comprising a micromirror device positioned between the source of illumination and the transparent substrate.

3. The system of claim 2, wherein the z-stage is configured to move upwardly by 200 μm to form the meniscus and then downwardly by 150 μm when the source of illumination is operated to cure a 50 μm layer of the resin.

4. The system of claim 3, wherein the transparent substrate is etched to define a flow path for the amount of resin and control the volume of the amount of resin in the meniscus.

5. The system of claim 4, further comprising at least a second continuous flow pump positioned to deliver a second amount of resin onto the transparent substrate.

6. The system of claim 5, wherein the first amount of resin and the second amount of resin are different.

7. The system of claim 5, wherein the first continuous flow pump and the second continuous flow pump are connected to a microfluidic mixer that provides a combination of the first amount of resin and the second amount of resin to the transparent substrate.

8. A method of performing projection stereolithography, comprising the steps of:
providing a Z-stage capable of movement along a first axis;
positioning a transparent substrate below and spaced apart from the Z-stage;
positioning a first continuous flow pump to pump a first amount of resin onto the transparent substrate;
providing a source of illumination below the transparent substrate that is oriented to selectively cure a portion of the first amount of resin;
pumping the amount of resin onto the transparent substrate to form a meniscus between the z-stage and the transparent substrate;
moving the Z-stage upwardly while continuing to pump the first amount of resin onto the transparent substrate to maintain the meniscus;
selectively polymerizing a region of the first amount of resin on the transparent substrate with the source of illumination to crosslink a first layer.

9. The method of claim 8, wherein the step of selectively polymerizing a region of the first amount of resin on the transparent substrate with the source of illumination includes using a micromirror device positioned between the source of illumination and the transparent substrate.

10. The method of claim 9, wherein the z-stage is moved upwardly by 200 μm when the continuous flow pump is pumping resin and then downwardly by 150 μm prior to the step of selectively polymerizing the region of the first amount of resin so that a 50 μm layer of the resin is cured.

11. The method of claim 9, wherein the transparent substrate is etched to define a flow path for the first amount of resin.

12. The method of claim 9, further comprising the step of using at least a second continuous flow pump to deliver a second amount of resin onto the transparent substrate.

13. The method of claim 12, wherein the first amount of resin and the second amount of resin have a different characteristic selected from the group consisting of color, composition, or additive.

14. The method of claim 13, wherein the first continuous flow pump and second continuous flow pump are coupled to a microfluidic mixer that provides a mixture of the first amount of resin and the second amount of resin to the transparent substrate.

15. The method of claim 10, further comprising the steps of moving the z-stage upwardly after the step of selectively polymerizing the region of the first amount of resin to raise the region of resin that has been polymerized to form a second region of the first amount of resin and then selectively polymerizing the second region of the first amount of resin.
